(19) United States
(12) Patent Application Publication
(10) Pub. No.: US 2023/0376320 A1
(43) Pub. Date: Nov. 23, 2023

(54) USER INTERFACE FOR INTERACTING WITH AN IFRAME

(71) Applicant: Microsoft Technology Licensing, LLC, Redmond, WA (US)

(72) Inventors: Brian Daniel MEERSMA, Princeton Junction, NJ (US); Brian Robert MARSHALL, Kirkland, WA (US); Marco CIMMINO GIBELLINI TORNIELLI BONIPERTI, San Francisco, CA (US); Jonathan Seth KAUFTHAL, Seattle, WA (US); Kenneth Dean STILL, Seattle, WA (US); Kenneth Kit Yu MUI, Kirkland, WA (US)

(73) Assignee: Microsoft Technology Licensing, LLC, Redmond, WA (US)

(21) Appl. No.: 17/748,656

(22) Filed: May 19, 2022

(51) Int. Cl. G06F 9/451; G06F 9/54; G06F 3/0482

(52) U.S. Cl. CPC G06F 9/451; G06F 9/542; G06F 3/0482

(57) ABSTRACT

A system and method enable an external user interface (UI) control for interacting with content in an iFrame web page to be invoked from within the iFrame and displayed outside the iFrame. The iFrame web page detects a predefined user interaction with a UI element in the iFrame web page and sends a UI request message to the host application using cross-domain communication. The host application activates the external UI control in response to receiving the UI request message and displays the external UI control outside of the iFrame element. User input is received with the external UI control and communicated from the host application to the iFrame web page and applied to the UI element.

### BACKGROUND

A web page is a document that can be read by web browsers for displaying designated information to users. A web page can include text, pictures, videos, or other suitable content items. A web page can also include style sheets, scripts, or other types of metadata describing how various content items are to be displayed. Upon receiving a web page, web browsers can render and output the various content items of the web page in accordance with the associated style sheets, scripts, or other types of metadata. Web browsers can also receive user input to a web page and enable user interaction with the displayed content items.

Web pages frequently use a form of HTML code called an iFrame (inline frame) to embed content into their pages. An iFrame is an element of a predetermined size and location on a web page. The iFrame enables content from another source, such as a web application, an advertisement or web analytics tool, to be embedded into a host web page. The use of iFrames limits the ability of content in the iFrame to access and control the host web page.

Due to the security restrictions imposed by iFrames, the content to be loaded into an iFrame must be displayed entirely within the boundary of the iFrame in the host web page. This can result in only a portion of the content being viewable at one time which can pose problems in interacting with the content in the iFrame. In addition, some content providers may implement user interface controls that enable a user to interact with the content. Since the available space within the iFrame is limited, displaying the user interface controls within the iFrame often results in the controls overlapping the content, obstructing the view of the user. in some cases, the user interface controls may be cropped by the boundary of the iFrame. In either case, the usability of the content in the iFrame is adversely impacted.

Hence, there is a need for systems and methods that enhance a user's ability to interact with content in an iFrame.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 is a diagram of a host application showing an iFrame element and an iFrame web page with a UI element in the form of a text field.

FIG. 3 is a diagram showing the host application and iFrame element of FIG. 2 with an external UI control in the form of a dialog.

FIG. 4 is a diagram of a host application showing an iFrame element and an iFrame web page with a UI element in the form of a rich edit box.

FIG. 5 is a diagram showing the host application and iFrame element of FIG. 4 with an external UI control in the form of a menu.

FIG. 6A is a flowchart of a method of communicating user input from an external control to a UI element of an iFrame web page.

FIG. 6B is a flowchart of a method of activating a UI control depending on whether the host application includes an external UI control.

FIG. 7 is a flowchart of a method of communicating user input from an external UI control to a UI element of an iFrame web page that utilizes a postMessaging method for communication.

FIG. 8 is a block diagram illustrating an example software architecture, various portions of which may be used in conjunction with various hardware architectures herein described.

FIG. 9 is a block diagram illustrating components of an example machine configured to read instructions from a machine-readable medium and perform any of the features described herein.

### SUMMARY

In one general aspect, the instant disclosure describes a computing device having a processor, and a memory in communication with the processor that includes executable instructions that, when executed by the processor, cause a computing device to perform multiple functions. The functions include detecting a predefined user interaction with a UI element in an iframe web page, the UI element for receiving the user input; in response to detecting the predefined user interaction with the UI element, sending a UI request message from the iFrame web page to a host application; in response to receiving the predetermined message, causing the host application to activate the external UI control; displaying the external UI control in a predetermined position with respect to the UI element; receiving the user input with the external UI control; and communicating the user input from the external UI control to the UI element.

In yet another general aspect, the instant disclosure describes a method of communicating a user input from an external user interface (UI) control to an iFrame web page that is loaded in an iFrame element in a host application with the external UI control being located outside of an iFrame element. The method includes the steps of detecting a predefined user interaction with a UI element in the iFrame web page, the UI element for receiving the user input; in response to detecting the predefined user interaction with the UI element, sending a request message from the iFrame web page to the host application; in response to receiving the UI request message, causing the host application to activate the external UI control; displaying the external UI control in a predetermined position with respect to the UI element; receiving the user input with the external UI control; and communicating the user input from the external UI control to the UI element.

In a further general aspect, the instant disclosure describes a non-transitory computer readable medium on which are stored instructions that, when executed, cause a programmable device to perform functions of detecting a predefined user interaction with a UI element in an iFrame web page, the UI element for receiving the user input; in response to detecting the predefined user interaction with the UI element, sending a predetermined message from the iFrame web page to a host application using a cross-domain communication method; in response to receiving the predetermined message, causing the host application to activate an external UI control; displaying the external UI control in a predetermined position with respect to the UI element; receiving the user input with the external UI control; and communicating the user input from the external UI control to the UI element.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

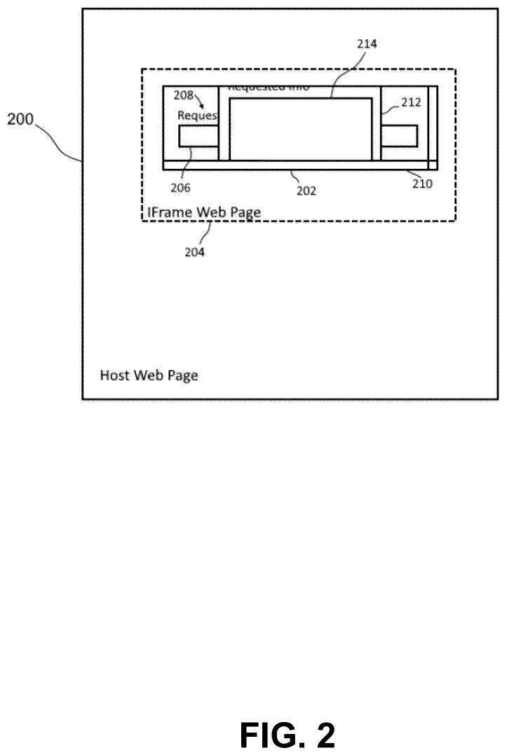

Due to security restrictions imposed by iFrames, the content to be loaded in an iFrame must be displayed entirely within the boundary of the iFrame in the host application. Consequently, if the content is larger in dimensions than those of the iFrame, the content will be clipped such that only a fraction of the content can be seen in the iFrame at one time. An example of this is depicted in FIG. 2 which shows a host application including an iFrame element. The size of the iFrame is controlled by the host application typically without regard to the size and/or type of web page to be displayed in the iFrame. As can be seen in FIG. 2, if the iFrame web page is larger than the iFrame element (as indicated by the dotted lines), only a portion of the iFrame web page will be visible within the boundary of the iFrame. Scrollbars may be used to enable the iFrame web page to be scrolled so that all parts of the web page may be viewed. However, not being able to view entire images, lines of text, text entry fields, or other elements in the iFrame web page at one time may be problematic for users.

In addition, a content provider may implement user interface (UI) controls, such as dialogs, menus, toolbars and types of elements, that allow a user to interact with content in specific ways. These UI controls may be invoked from within the iFrame and displayed within the frame to facilitate a user's interaction with the content. Since the available space within the iFrame is limited, displaying the UI controls often results in the UI controls overlapping the content and obstructing the view of the user. In some cases, the internal UI controls themselves may be clipped to fit within the iFrame boundary. In either case, the usability of the content in the iFrame may be negatively impacted.

One previously known method that may be used to alleviate the difficulties associated with interacting with iFrame content and the use of internal UI controls in an iFrame is to dynamically increase the size of the iFrame to accommodate the content and the UI controls. However, this solution can result in unwanted changes to the layout of the host application and also limit the space available for content from the host application.

To address these technical problems and more, in an example, this description provides technical solutions in the form of external UI controls (as in external to the iFrame) implemented by a host application which may be invoked from within the iFrame and displayed by the host application outside of the iFrame. As used herein, the term “host application” is used to refer to any application capable of hosting an iFrame including but not limited to a desktop application, web application, web page, or another iFrame. In embodiments, the iFrame web page includes at least one UI element configured to be interacted with by a user. Examples of UI elements include input elements for receiving input from a user and media elements, such as audio, video and images, that may be consumed and/or manipulated in some way by users. The iFrame web page is configured to detect the UI element currently being interacted with by a user. The iFrame web page is also configured to detect predefined user interactions with the active UI element. Examples of predefined user interactions include keyboard shortcuts, mouse clicks, touch input (in the case of touch screens), and the like. In response to detecting the predefined user interaction with a particular UI element, the iFrame web page is configured to send a message to the host application requesting that a particular external UI control be displayed by the host application.

The external UI control requested by the iFrame web page depends on the type of UI element being interacted with by the user at the time. For example, when the active UI element is an input element for receiving a certain type of input from a user, the iFrame web page may request an external UI control for receiving the type of input associated with the input element. Examples of types of input that may be associated with different input elements in an iFrame web page include plain text, rich text, numbers, dates, times, hyperlinks, and the like. When the active UI element is a media element, the iFrame web page may request an external UI control for interacting with the media element. For example, if the media element is a video, the external UI control may be a toolbar or similar type of control with buttons for controlling the playback of the video. The iFrame web page may also request other types of external UI controls to facilitate interaction with UI elements. For example, the iFrame web page may request menus, such as context menus, that provide selectable options for manipulating content in the iframe. Examples of selectable options include formatting options for formatting text within a UI element. Menus may also include commands for calling other UI controls.

The host application is provided with the ability to implement the various external UI controls that may be requested by the iFrame web page. For example, the external UI controls may include dialogs with different input controls for receiving the various types of input from the user, menus including the selectable options and commands enabled by the iFrame web page, and media interfaces for controlling and manipulating media. The host application may already have the capability to implement certain dialogs and other UI controls that may be requested by the iFrame web page. For example, external UI controls may be implemented using a scripting language, such as JavaScript, or other suitable type of programming language or method. In some cases, the iFrame web page may require custom UI controls for interacting with certain UI elements. In this case, the custom UI controls may be provided to the host application and integrated into the code of the host application in any suitable manner.

In response to receiving the request for a particular external UI control, the host application displays the requested UI control in the host application to wait for input from the user. The predetermined position may be relative to the host application, the iFrame element, and/or the content in the iFrame element. Once the external UI control has completed receiving input from the user, the host application sends the user input to the iFrame web page. The iFrame web page then provides the user input to the appropriate UI element within the iFrame web page. For example, the user input may include data for entry into an input element, a command for formatting text in a UI element, a command for manipulating a media element, and the like. Once the external UI control has received the input from the user, the external UI control may be dismissed.

The host application and/or the iFrame web page may include one or more application programming interfaces (APIs) that provide standards for communicating data and functions that may be called to implement the functionality of the system. In addition, a cross-domain communication method, such as the post Message method, or “postMessaging,” is used to enable communication between the host application and the iFrame and via which data and API calls may be passed.

The benefits and advantages provided by such implementations can include, but are not limited to, a technical solution to the technical problems associated with interacting with the content within an iFrame. Technical solutions and implementations provided herein offer mechanisms for utilizing external UI controls for interacting with UI elements in an iFrame web page that may be invoked from within the iFrame web page and displayed outside of the iFrame web page by the host application. The benefits made available by these technology-based solutions enhance the user's experience and efficiency in interacting with name content.

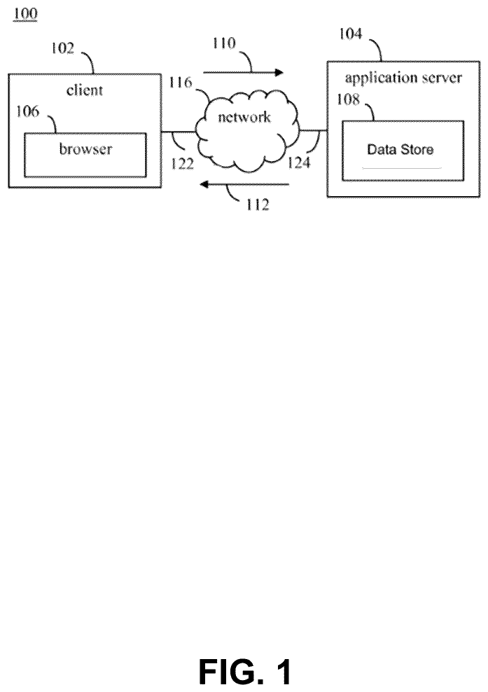

FIG. 1 shows an example system 100, upon which aspects of this disclosure may be implemented. The system 100 includes a client 102, an application server 104, and a network 116, is described herein as follows to illustrate delivery of web applications to clients. Client 102 may be any type of computing device, including a desktop computer (e.g., a personal computer), a mobile computer or computing device (e.g., a laptop computer, notebook computer, etc.), a smart phone, or other type of computing device.

Application server 104 may include one or more servers, which may be any type of computing device described herein or otherwise known that enables web applications to be served. The application server 104 includes one more data stores, such as data store 108, for storing files associated with web pages. Client 102 and application server 104 are communicatively coupled by network 116. Network 116 may include one or more communication links and/or communication networks, such as a PAN (personal area network), a LAN (local area network), a WAN (wide area network), or a combination of networks, such as the Internet. First and second communication links 122 and 124, which respectively couple client 102 and application server 104 to network 116, may include any number of communication links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

System 100 is configured to enable client computer systems such as client 102 to retrieve content from a web application via the application server 104. A web application is an application that is accessed over the network and that enables users to consume, create, share, collaborate on, and/or modify content. As shown in FIG. 1, client 102 includes a host application 106, such as a web browser or other application, for accessing and displaying the content from the web application. Host application 106 is a software application designed to retrieve information over the internet, and to render the retrieved information on a display device of the client 102 where it can be accessed and reviewed by a user. To access a web application, a user may input an address of the web application in the form of a Uniform Resource Locator (“URL”) into the client application 106, which causes the client application to send a request 110 to request one or more files from the application server 104 that are needed to construct a web page and render it on a display device of the client device. The application server 104 returns the requested files 112 to the client device 102. The requested files are usually extensible mark-up language (“XML”) or hyper-text markup language (“HTML”) files and are used by the client application 106 to render a web page in an appropriate format in the browser window on the display device.

The web page rendered on the client device may include an iFrame element in which a web page may be loaded. FIG. 2 is a simplified depiction of a host application 200 including an iFrame element 202. The iFrame may be a sourced or a sourceless iFrame element. A sourced iFrame element includes a src (source) attribute which defines a “URL” that is to be loaded into the iFrame element 202. In a sourceless iFrame element, the code that defines the iFrame web page is provided in the iFrame element itself The web browser 106 is configured to retrieve the web page 204 (or iFrame web page) pointed to by the “URL” and to render the iFrame web page 204 in an appropriate format within the iFrame element 202.

The iFrame web page 204 may be associated with a web application or other source and, as such, may include interactive content in the form of UI elements, such as the UI element 206, that are capable of being interacted with by a user in specific ways. Examples of UI elements that may be included in an iFrame web page to be loaded into iFrame element 202 include input elements for receiving different types of input from a user and media elements capable of being controlled and/or manipulated in some way by a user. Examples of input elements include plain text fields for receiving plain text, rich text fields for receiving rich text (e.g., formattable text), link fields for receiving hyperlinks, date fields for receiving dates, fields for receiving a particular format of data (e.g., decimal numbers, currency, etc.). Examples of media elements include images, audio and video which may be manipulated by the user. These examples of UI elements are not limiting as the iFrame web page may include any type of interactive UI elements known in the art. The UI element 206 in FIG. 2 may be in the form of an input element for receiving text from a user, e.g., a text field. The iFrame web page may include text labels, such as text label 208, indicating what information is to be entered in the input element 206.

The iFrame web page 204 may be larger than the iFrame element 202 resulting in only a portion of the iFrame web page 204 being visible within the boundary of the iFrame element 202, as can be seen in FIG. 2. The portions of the iFrame web page that are not visible are indicated by the dotted lines. Scrollbars 210 may be provided by the iFrame element to enable the iFrame web page 204 to be scrolled so that all parts of the web page 204 may be viewed. The iFrame web page 204 may include an internal control 212 that may be invoked within the iFrame 202 for interacting with the UI element 206 in the iFrame web page 204. The internal UI control 212 in this case is in the form of a dialog including an input control 214 for receiving text as an input. Because the internal UI control 212 is a part of the iFrame web page, it cannot be displayed outside of the boundary of the iFrame element 202. This may result in the internal UI control 212 being clipped by the boundary of the iFrame element 202 such that only a portion of the dialog may be visible to the user, as can be seen in FIG. 2.

To address the problems associated with interacting with UI elements in an iFrame web page, the present disclosure provides a technical solution in the form of external UI controls which may be invoked from within the iFrame and displayed by the host application outside of the iFrame. The iFrame web page includes UI elements which may be displayed in the iFrame web page and internal UI controls which may be implemented within the iFrame web page to interact with the UI elements. Examples of UI elements include input elements for receiving input data from a user and media elements, such as audio, video and images, that may be consumed and/or manipulated in some way by users. The iFrame web page includes at least one internal UI control for interacting with at least one UI element in the iFrame web page. The Examples of internal UI controls include dialogs with input controls for facilitating the input of data to an input element, menus including the selectable options and commands for implementing functionality of the iFrame web page, medio interfaces for controlling and manipulating media, and the like. In embodiments, the host application includes at least one external UI control for providing input to at least one UI element in the iFrame web page. The external UI control(s) implemented in the host application may have any suitable configuration for interacting with the associated UI element in the manner prescribed by the iFrame web page. In embodiments, the external UI control(s) may be the same type of UI control as the corresponding internal UI control(s) implemented in the iFrame web page. Internal and external UI controls may be implemented using a scripting language, such as JavaScript, or other suitable type of programming language or method. In some cases, the iFrame web page may require custom UI controls for interacting with certain UI elements. In this case, the custom UI controls may be provided to the host application and integrated into the code of the host application in any suitable manner.

Because the external UI controls are implemented in the host application, the external UI controls can be displayed outside of the boundary of the iFrame While still allowing normal or intended interaction with the UI elements within the iFrame web page. Each external UI control is associated with a specific type of UI element and is configured to interact with that type of LT element in a specific way. For example, an external UI control for interacting with a UI element in the form of a plain text field, such as the UI element 206 of FIG. 2, is configured to receive text as input. An external UI control for interacting with a rich text field is configured to receive rich text as input, an external control for interacting with a date field is configured to receive a date as input, and so on.

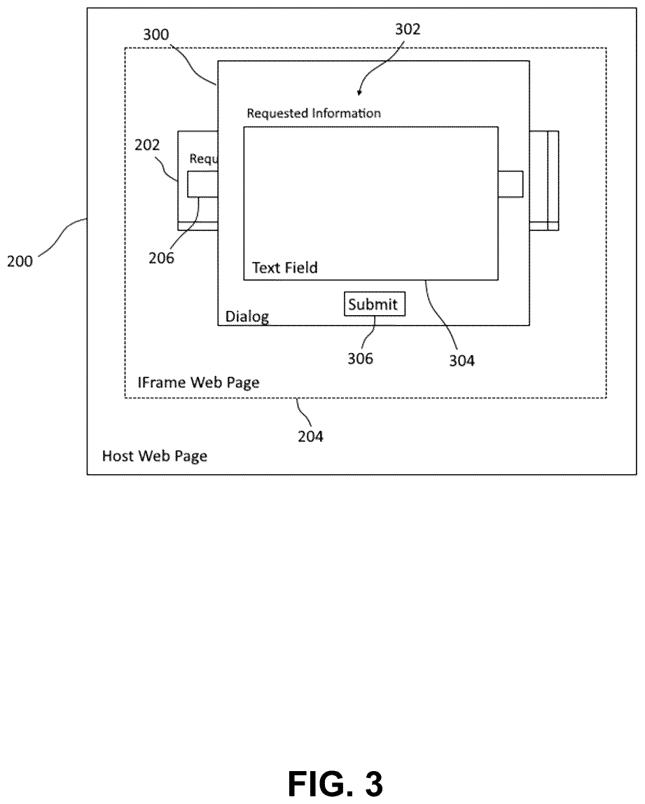

With reference to FIG. 3, the external UI control is in the form of a dialog 300. The dialog includes at least one input control, such as input control 304, configured to receive input from a user. Examples of the type(s) of input control(s) that may be provided in the dialog include plain text fields, rich text fields, data fields for receiving different types of data formats (e.g., dates, times, hyperlinks, currency, decimal numbers, currency, and the like). Input controls may also include checkboxes, comboboxes, listboxes, radio buttons, and the like that allow a user to make selections of options provided on the dialog. The dialog may also include a label 302 displayed on the dialog indicating the information requested for the input controls) and/or for providing instructions for interacting with the input control(s). The dialog is associated with at least one UI element 206 and is configured to provide user input to the element 206. The element 206 is configured to receive a certain type of input from the user. For example, the UI element 206 may be in the form of a text field. In this case, the input control 304 provided on the dialog 300 is a text field in which text may be entered by a user. The label 302 on the dialog is used to describe what information is to be entered into the text field.

Because the dialog 300 is implemented in the host application, it is not constrained by the size of the iFrame element. Therefore, the dialog 300 can extend beyond the boundary of the iFrame 202, as depicted in FIG. 3, which enables the user to easily see the entire dialog including the input control(s) and label. The dialog 300 may include a submit control 306, such as a button, for indicating that the user is done providing input to the dialog and that the user input should be sent to the UI element 206 in the iFrame web page 204. The dialog 300 may then be dismissed.

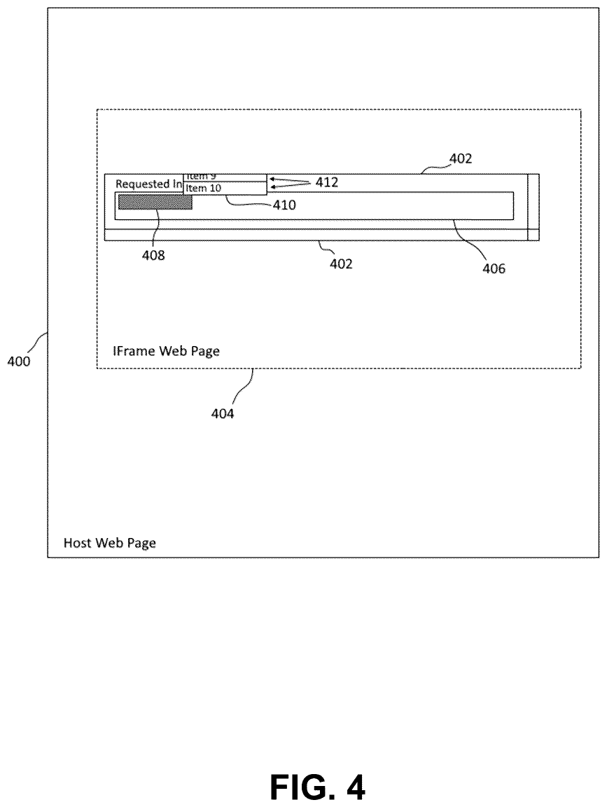

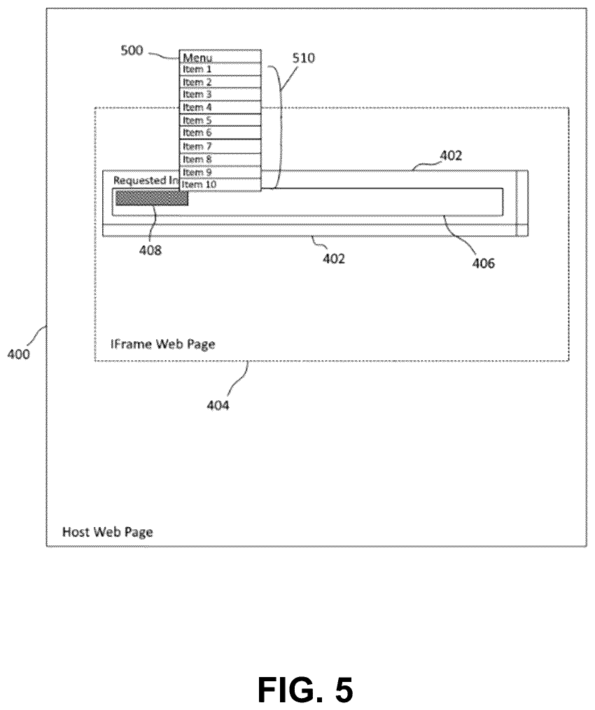

Another example of an external UI control will now be described with reference to FIGS. 4 and 5. FIG. 4 depicts a host application 400 having an iFrame element 402, and an iFrame web page 404 loaded into the iFrame element 402. In this embodiment, the iFrame web page 404 includes a UI element 406 that enables a user to enter rich text 408, i.e., formattable text, into the UI element 406. The iFrame web page 404 may include an internal UI control 410 in the form of a menu 408 that may be invoked by a user, e.g., by pressing the right button on a mouse, while the input focus is located in the UI element 406. The menu may include several selectable options 412 including formatting options for formatting the text entered into the UI element as well as commands for implementing other functionality of the iFrame web page. However, since internal UI controls are constrained to the boundary of the iFrame element, the menu may be clipped by the iFrame element such that only a portion of the menu may be visible within the iFrame element, such as depicted in FIG. 4.

Referring to FIG. 5, the host application is configured to implement an external UI control in the form of a menu, or context menu, that may be invoked from within iFrame web page and displayed outside of the iFrame element. The external menu may be in the same form as the internal menu and include the same selectable options and commands as the internal menu. The menu 500 is not constrained to the boundary of the iFrame element 402 and therefore may extend past the boundary of the iFrame, as depicted in FIG. 5. Different menus may be implemented for different UI elements so that different selectable options and commands that are relevant to the UI element may be presented to the user. Once the external menu 500 has been activated, a user may select one of the options in the menu at which point the user selection is communicated to the iFrame web page 404 and the menu is dismissed.

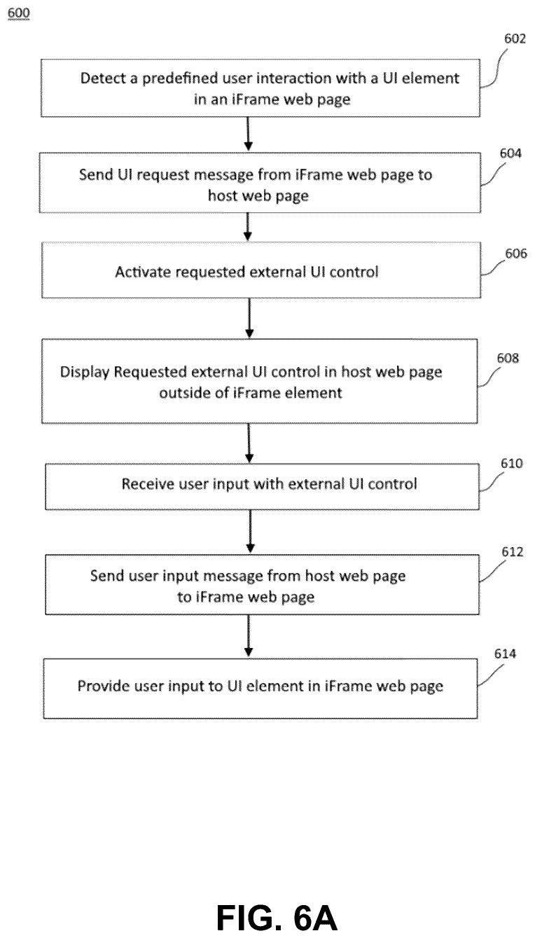

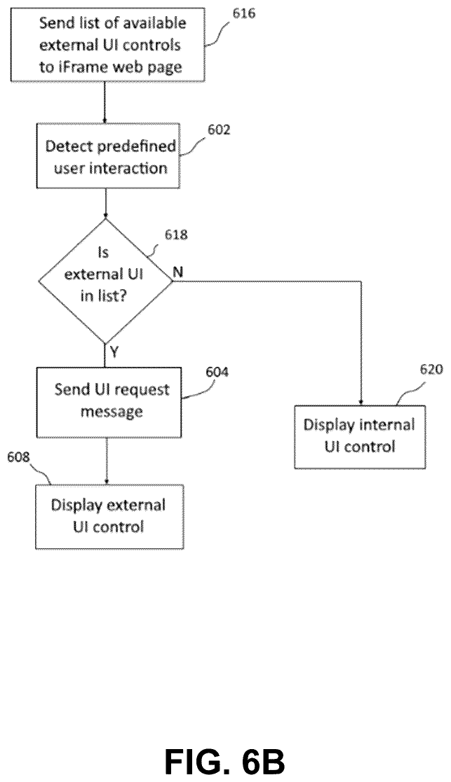

An example of a method of activating an external UI control and using the external UI control to provide input to a UI element in an iFrame web page will now be described with reference to FIG. 6A. The method begins with the detection of a predetermined user interaction with a UI element in the iFrame web page (block 602). For example, the iFrame web page may include functionality in the form of a JavaScript applet or other scripting function for detecting the UI element that a user is currently interacting with (i.e., the active UI element) and for detecting predefined user interactions with the element. Predefined user interactions may include keyboard shortcuts, mouse clicks (right or left), and touch input (e.g., long presses or swipes) while input is focused in or on the UI element. In response to detecting the predefined user interaction with the UI element, the iFrame web page is configured to send a UI request message to the host application (block 604).

The UI request message may include any information that enables the host application to activate the external UI interface for providing the appropriate input to the active UI element in the iFrame web page. For example, in embodiments, the UI request message may include information identifying a specific external control or a type of external UI control to implement (e.g., dialog, menu, etc.). In the case of dialogs, the information may include the number and type(s) of input control to use in the dialog as well as label text to display on the dialog. In the case of menus, the information may identify the selectable options to include in the menu. The information in the UI request message may also include position information, such as coordinates, indicating what position to display the external UI control in relation to the iFrame.

In response to receiving the UI request message from the iFrame web page, the host application is configured to trigger the activation of the requested external UI control (block 606) causing the external UI control to be displayed in the host application outside of the iFrame and in a predetermined position with respect to the iFrame (block 608). The external UI control receives user input from a user via an input device, such as a keyboard, mouse or touchscreen, of the client device (block 610). The host application then sends a user input message to the iFrame web page indicating the user input to the external UI control (block 612). For example, in the case of dialogs, the user input is received via the one or more input controls, and the user input message is sent in response to the user actuating the submit control on the dialog. In the case of menus, the user input corresponds to a selection of a menu item by a user, and the message indicates the selected option. The host application and/or the iFrame web page may utilize one or more APIs to define the format and attributes of the UI request message and the user input message as well as how to call functions which may be used to implement the functionality of the iFrame web page. The iFrame web page then provides the user input to the active UI element and the results of the user input are reflected in the UI element.

In embodiments, the host application may not include external UI controls for every UI element implemented in the iFrame web page. An example of a method for activating a UI control for a UI element in an iFrame web page Which takes this possibility into account is shown in FIG. 6B. The method begins with the host application sending a message to the iFrame web page, e.g., using a postMessaging method, including a list of the external UI controls that the host application is capable of implementing for the iFrame web page (block 616). The iFrame web page detects a predetermined user interaction with a UI element in the iFrame web page (block 602). For example, the iFrame web page may include functionality in the form of a JavaScript applet or other scripting function for detecting the UI element that a user is currently interacting with (i.e., the active UI element) and for detecting predefined user interactions with the UI element. Predefined user interactions may include keyboard shortcuts, mouse clicks (right or left), and touch input (e.g., long presses or swipes) while input is focused in or on the UI element.

In response to detecting the predefined user interaction with the UI element, the iFrame web page is configured to determine from the list received from the host application whether or not the host application includes the external UI control associated with that UI element (block 618). If the host application does include the external UI control for the UI element, the iFrame web page is configured to send a UI request message to the host application requesting that external UI control (block 604) and the requested external UI control is activated and displayed in the host application as described above (block 608). If the requested external UI control is not implemented in the host application, the iFrame web page may activate the internal UI control for the active UI element (620).

Due to the restrictions on cross-domain communication imposed by iFrames, a secure communication channel may be required to enable the messages, such as the UI request message and user input message, to be passed between the iFrame web page and the host application. A secure communication channel generally provides for cross-domain communication between a parent web page, such as the host application, which is hosted on one domain and a child web page, such as the iFrame web page, hosted on a different domain. The cross-domain communication takes place completely within the web browser of a client device, such as the client device 102 of FIG. 1. Any suitable cross-domain communication method may be used. One method exemplary method of establishing a secure cross-domain messaging channel that may be used to enable communications between the host applications and iFrame web pages is the postMessaging method. The postMessaging method uses a postMessage function provided by Java, JavaScript, or a web API to establish a secure communication channel that allows messages to be passed between domains in a safe and secure manner. The postMessaging method takes two arguments: the message to be sent (data), and the domain to which the message is to be sent. The data field of the postMessage may include the information associated with the UI request message and user input message as well as any other messages communicated between the host application and the iFrame web page.

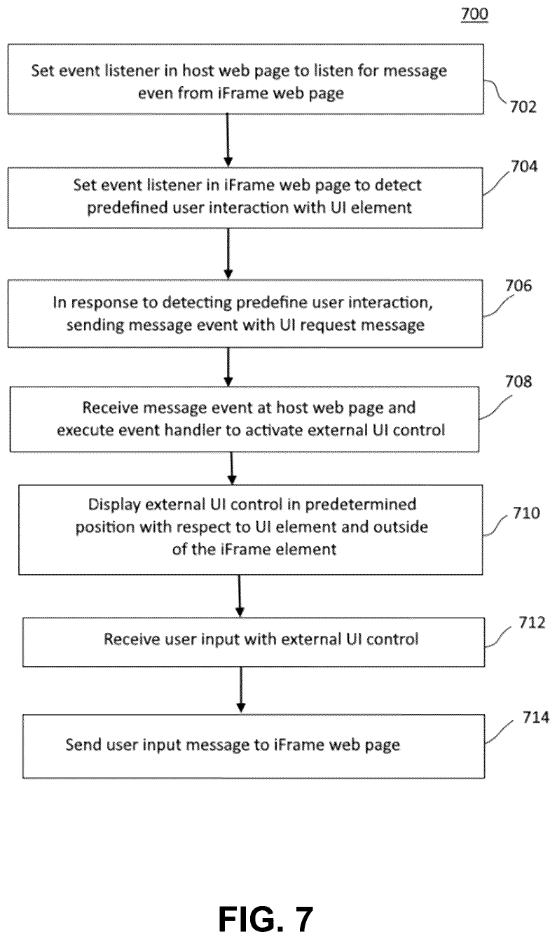

An example of a method 700 of communicating a user input from an external UI to a UI element that utilizes a postMessaging method for communication is shown in FIG. 7. The method 700 begins with the execution of a JavaScript function that creates an event listener in the host application that listens for a message event in the form of an incoming message from the iFrame web page (block 702). In addition, a JavaScript function is executed in the iFrame web page that creates an event listener that listens for an event in the form of a predefined user interaction with an active UI element in the iFrame web page (block 704). When the predefined user interaction event is detected, a JavaScript function is executed by the iFrame web page that causes a message event with a UI request message to be sent to the host application using the postMessaging method (block 706). The UI request message may be included in data field of the message. The host application receives the incoming message from the iFrame web page and a message event is fired on the host application which calls an event handler to handle the message (block 708). The event handler, in this case, is configured to handle the request message by activating the requested external UI control and displaying the requested external UI control in the host application and in a predetermined position with respect to the iFrame (block 710). The external UI control receives a user input from a user, such as by using a keyboard or mouse of the client device (block 712). The host application then sends a user input message to the iFrame web page using the postMessageing method (block 714). The iFrame web page then provides the user input to the active UI element and the results of the user input are reflected in the UI element.

The detailed examples of systems, devices, and techniques described in connection with FIGS. 1-7 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-7 may be implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured. circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

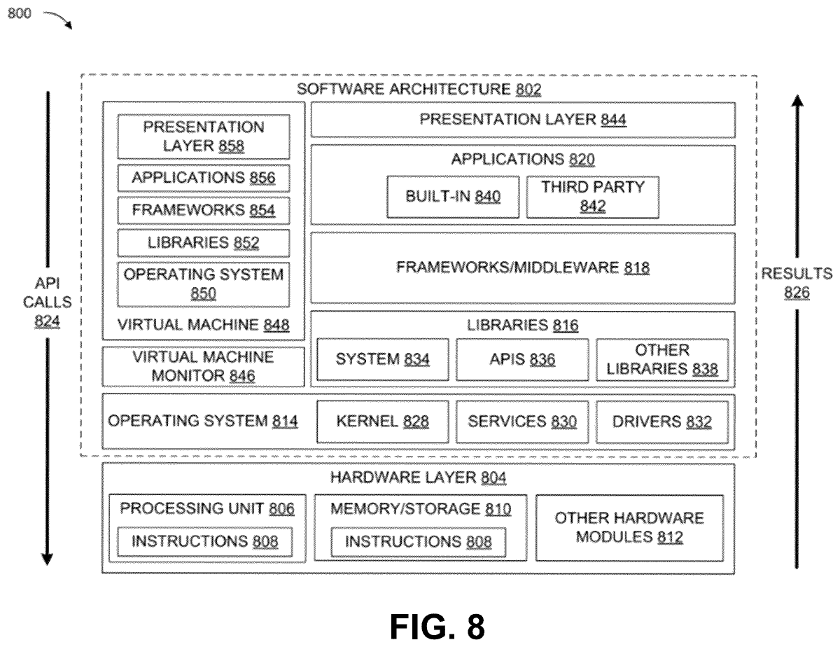

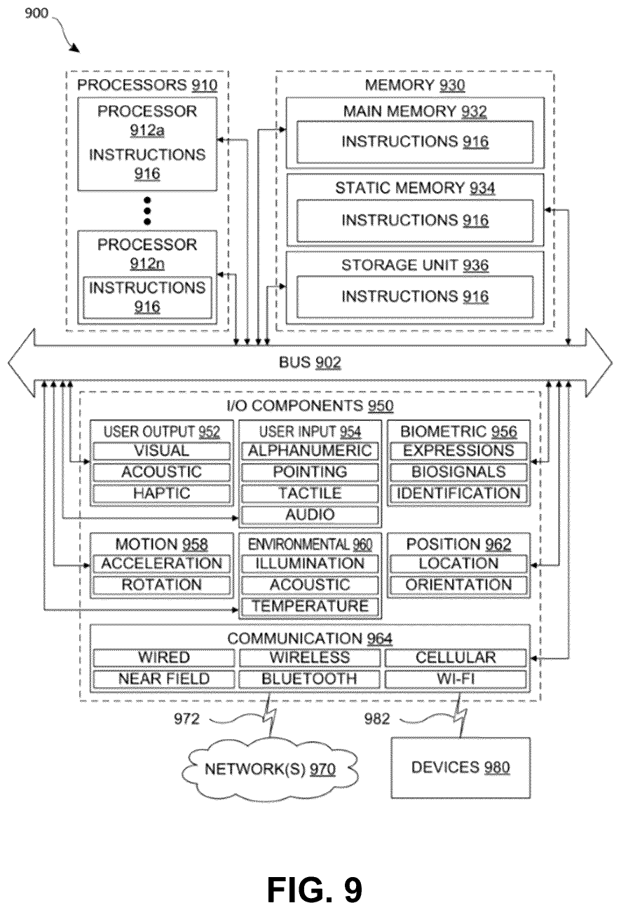

FIG. 8 is a block diagram 800 illustrating an example software architecture 802, various portions of which may be used in conjunction with various hardware architectures herein described, which may implement any of the above-described features. FIG. 8 is a non-limiting example of a software architecture, and it will be appreciated that many other architectures may be implemented to facilitate the functionality described herein. The software architecture 802 may execute on hardware such as a machine 900 of FIG. 9 that includes, among other things, processors 910, memory 930, and input/output (I/O) components 950. A representative hardware layer 804 is illustrated and can represent, for example, the machine 900 of FIG. 9. The representative hardware layer 804 includes a processing unit 806 and associated executable instructions 808. The executable instructions 808 represent executable instructions of the software architecture 802, including implementation of the methods, modules and so forth described herein. The hardware layer 804 also includes a memory/storage 810. which also includes the executable instructions 808 and accompanying data. The hardware layer 804 may also include other hardware modules 812. Instructions 808 held by processing unit 806 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks 818, applications 820, and a presentation layer 844. Operationally, the applications 820 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks 818 (also sometimes referred to as middleware) provide a higher-level common infrastructure that may be used by the applications 820 and/or other software modules. For example, the frameworks 818 may provide various graphic user interface (GUI) functions, high-level resource management, or high-level location services. The frameworks 818 may provide a broad spectrum of other APIs for applications 820 and/or other software modules.

The applications 820 include built-in applications 840 and/or third-party applications 842. Examples of built-in applications 840 may include, but are not limited to, a contacts application, a browser application, a location application, a media application, a messaging application, and/or a game application. Third-party applications 842 may include any applications developed by an entity other than the vendor of the particular platform. The applications 820 may use functions available via OS 814, libraries 816, frameworks 818, and presentation layer 844 to create user interfaces to interact with users.

Some software architectures use virtual machines, as illustrated by a virtual machine 848. The virtual machine 848 provides an execution environment where applications/modules can execute as if they were executing on a hardware machine (such as the machine 900 of FIG. 9, for example). The virtual machine 848 may be hosted by a host OS (for example, OS 814) or hypervisor, and may have a virtual machine monitor 846 which manages operation of the virtual machine 848 and interoperation with the host operating system. A software architecture, which may be different from software architecture 802 outside of the virtual machine, executes within the virtual machine 848 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement modules or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (CPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multi-core processor including cores that may execute instructions contemporaneously. Although FIG. 9 shows multiple processors, the machine 900 may include a single processor with a single core, a single processor with multiple cores (for example, a multi-core processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “machine-readable medium” refers to a device able to temporarily or permanently store instructions and data that cause machine 900 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956, motion components 958, environmental components 960, and/or position components 962, among a wide array of other physical sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 958 may include, for example, acceleration sensors (for example, an accelerometer) and rotation sensors (for example, a gyroscope). The environmental components 960 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 964 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 962, such as, hut not limited to, geo-location via Internet Protocol (IP) address, location via Wi-Fi, cellular NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A computing device comprising:
a processor; and
a memory in communication with the processor, the memory comprising executable instructions that, when executed by the processor, cause the computing device to perform functions of:
detecting a predefined user interaction with a User Interface (UI) element in an iFrame;
in response to detecting the predefined user interaction with the UI element, sending a UI request message from the iFrame to a host application containing the iFrame;
in response to receiving the request message, causing the host application to activate an external UI control corresponding to the UI element in the iFrame, wherein the external UI control is displayed outside of current boundaries of the iFrame within a display of the host application;
receiving user input with the external UI control; and
communicating the user input from the external UI control to the UI element of the iFrame.

2. The computing device of claim 1, wherein the predefined user interaction is one of a keyboard shortcut, a mouse click, and a touch input.

3. The computing device of claim 1, wherein detecting the predefined user interaction includes:
executing an event listener function of a web page displayed in the iFrame to detect the predefined user interaction with the UI element; and
sending the UI request message in response to the event listener function detecting the predefined user interaction.

4. The computing device of claim 1, wherein a web page display content in the iFrame uses a custom UI control, the custom UI control being provided to the host application for use as the external UI control displayed outside of the iFrame.

5. The computing device of claim 1, wherein the external UI control is implemented in the host application.

6. A method of communicating a user input from an external user interface (UI) control to an iFrame web page, the iFrame web page being loaded in an iFrame element in a host application, the external UI control being located outside of the iFrame element, the method comprising:
communicating a predefined user interaction with a UI element in the iFrame to the iFrame web page, the UI element for receiving user input;
after communicating the predefined user interaction with the UI element, receiving a UI request message from the iFrame web page to the host application;
in response to receiving the UI request message, causing the host application to activate the external UI control corresponding to the UI element in the iFrame, wherein the external UI control is displayed outside of current boundaries of the iFrame within a display of the host application;
receiving the user input with the external UI control; and
communicating the user input from the external UI control to the UI element of the iFrame.

7. The method of claim 6, further comprising dismissing the external UI control from the display of the host application after receiving the user input with the external UI control.

8. The method of claim 6, further comprising detecting the predefined user interaction by:
executing an event listener function in the iFrame web page to detect the predefined user interaction with the UI element; and
sending the UI request message in response to the event listener function detecting the predefined user interaction.

9. The method of claim 8, wherein the message is sent using a postMessaging method.

10. The method of claim 6, wherein the external UI control is displayed over the iFrame element in the iFrame web page such that external UI control extends past a boundary of the iFrame element in at least one dimension.

11. The method of claim 6, wherein the external UI control is implemented in the host application.

12. The method of claim 11, wherein the external UI control is a dialog including an input control for receiving the user input from a user.

13. The method of claim 12, wherein the input control is configured to receive a type of data corresponding to a type of data to be input to the UI element.

14. The method of claim 6, wherein the external UI control is a menu including selectable menu items.

15. The method of claim 6, wherein the external UI control corresponding to the UI element in the iFrame is implemented in the host application.

16. The method of claim 14, wherein the menu includes different menu items depending on the UI element.

17. The method of claim 6, wherein the user input is communicated from the host application to the iFrame web page using a postMessaging method.

18. A non-transitory computer readable medium on which are stored instructions that, when executed, cause a programmable device to perform functions of:
detecting a predefined user interaction with a User Interface (UI) element of an iFrame web page in an iFrame;
in response to detecting the predefined user interaction with the UI element, sending a predetermined message from the iFrame web page to a host application that is displaying the iFrame using a cross-domain communication method;
the predetermined message causing the host application to activate an external UI control corresponding to the UI element in the iFrame, wherein the external UI control is displayed outside of current boundaries of the iFrame and within a display of the host application; and
receiving user input from the external UI control to the UI element of the iFrame.

19. The non-transitory computer readable medium of claim 18, wherein the external UI control is a dialog including in input element for receiving the user input.

20. The non-transitory computer readable medium of claim 18, wherein the external UI control is a menu and the user input is a selection of a menu item from the menu.
